(19) United States
(12) Patent Application Publication
(10) Pub. No.: US 2026/0320186 A1
(43) Pub. Date: Oct. 15, 2026

(54) ENRICHED RULE-BASED THREAT DETECTION IN SECURITY SYSTEMS

(71) Applicant: Microsoft Technology Licensing, LLC, Redmond, WA (US)

(72) Inventors: Shany Klein ANTMAN, Kfar Saba (IL); Ron Moshe MARSIANO, Ashqelon (IL); Diana ATTAR-SITYON, Ganey-Tikva (IL); Hen AZRAN, Ashdod (IL); Noam DRUKER, Tel Aviv (IL)

(21) Appl. No.: 19/177,477

(22) Filed: Apr. 11, 2025

(51) Int. Cl. G06F 21/56; G06F 21/55

(52) U.S. Cl. CPC G06F 21/56; G06F 21/554

(57) ABSTRACT

Aspects herein pertain to a form of detection rule enrichment, in which a detection rule implemented in a security system is enriched with relevant context to assist actions such as reporting or remediation when the rule is triggered based on pattern matching to telemetry. A two-stage rule classification process is disclosed, where a first classifier assigns a first threat classification label (e.g., tactic) and a second classifier assigns a second threat classification label (e.g., technique). The classification is hierarchical in that second classifier uses the output of the first classifier (the first threat classification label) to determine the second threat classification label.

### TECHNICAL FIELD

The present disclosure pertains generally to security systems, and in particular to an enriched form of rule-based threat detection in which detection rules are enriched with relevant and targeted security context to assist security analysts or automated remediation system at detection time.

### BACKGROUND

In cybersecurity, speed of threat response is crucial. When an attacker compromises a network, system or device, it is vital to outpace the attacker. Having compromised a system, an attacker will use tactics such privilege escalation and credential access to increase their foothold. Speed of response can be the difference between thwarting a nascent attack and the attacker causing catastrophic damage.

A security operations center (SOC) is an environment where a team closely monitors infrastructure to identify emerging threats in a timely manner. This center often includes analysts working with automated monitoring tools that continuously observe network activity, server usage, and other system behaviors. Malicious entities may gain traction rapidly if detection lags, so swift alerts and responses are critical. Without quick intervention, unauthorized activities could escalate, potentially leading to data loss or service interruptions. This is merely one example of a security context where speed of response is crucial. As another example, an automated remediation system may deploy similar techniques to mitigate against an attack or other security threat in an automated fashion.

By structuring how detection rules are defined and referenced in such environments, an organization can better coordinate information needed for analyzing or remediating incidents. For instance, detection rules might specify conditions that alert administrators to irregular user logins or unauthorized file changes. When these rules are enforced, the security operations center can rapidly process incoming signals and decide if a deeper investigation or a direct containment step is warranted. It is important that relevant information is surfaced when potential threat indicators are detected. For example, when a rule-based detection is triggered, it is important to provide useful and targeted security context to the detection to enable an analysist to automated system to respond appropriately at speed. Without precise, targeted context, it can be challenging or impossible for an analysis or automated system to determine the significance of a detection.

### SUMMARY

Aspects herein pertain to a form of detection rule enrichment, in which a detection rule implemented in a security system is enriched with relevant context to assist actions such as reporting or remediation when the rule is triggered based on pattern matching to telemetry. A two-stage rule classification process is disclosed, where a first classifier assigns a first threat classification label (e.g., tactic) and a second classifier assigns a second threat classification label (e.g., technique). The classification is hierarchical in that second classifier uses the output of the first classifier (the first threat classification label) to determine the second threat classification label.

This summary is provided to introduce a selection of concepts in a simplified form that are further described below in the Detailed Description. This Summary is not intended to identify key features or essential features of the claimed subject matter, nor is it intended to be used to limit the scope of the claimed subject matter. Nor is the claimed subject matter limited to implementations that solve any or all of the disadvantages noted herein.

### BRIEF DESCRIPTION OF FIGURES

Example embodiments will now be described with reference to the following figures, in which:

FIG. 1 depicts an example high-level system architecture comprising a configuration system and a security system.

FIG. 2 shows an example hierarchical rule classifier that assigns a tactic and a subsequent technique to a rule.

FIG. 3 shows an example training setup for tactic classification training.

FIG. 4 shows an example second training setup for technique classification training.

FIG. 5 depicts an example computer architecture.

### DETAILED DESCRIPTION

A detection rule typically contains machine-readable code that sets the conditions under which the rule is activated. Kusto Query Language (KQL) can serve this purpose, as can alternatives like Search Processing Language (SPL) or Event Query Language (EQL). By defining what activity qualifies as abnormal, these rules enable targeted responses that minimize wasted time and reduce the risk of missing a critical event. In the broad sense, such rules are based on pattern detection. A rule defines a pattern or class of patterns and is activated when a matching pattern is detected in telemetry collected and processed by a security system. In contrast to machine learning (ML)-based detection, such patterns are explicitly defined in machine-readable code, using a structured syntax or language interpretable by a detector.

When a suspicious pattern is detected, an appropriate security response can be triggered. This might occur when repeated login failures suggest an ongoing attempt to discover valid credentials or when unusual access to sensitive files indicates a stealth intrusion. Once a situation is identified as abnormal, the security system activates a predefined procedure to protect vital resources from harm. This involves adapting infrastructure to counter new findings, thereby strengthening an organization’s defenses. For example, it may entail updating firewall settings, isolating suspicious hosts from the network, or locking down compromised accounts.

However, as noted, the ability to respond to a detection in a fast and targeted manner is highly dependent on the quality of the contextual information surfaced with the detection, as this enables an analyst or automated system to interpret the detection. Embodiments herein use a form of ML classification to enrich detection rules with targeted context. For example, in some embodiments, a detection rule is enriched with an associated attack tactic or technique. Note, in this context, the detection itself is rule-based (in contrast to ML-based pattern detection applied to telemetry), whilst ML is used to enrich the detection rule with additional context. This approach benefits on the one hand from the predictability and auditability of a rules-based approach to threat detection, whilst at the same time benefiting from the flexibility and enhanced capabilities of machine learning. Rules-based detection is applied to telemetry, but the rules themselves are enriched using ML technology. This approach leverages the strengths of both approaches, ultimately providing a security improvement in a security system in which the enriched rule is deployed.

For example, in some embodiments, a detection rule is enriched with a tactic and technique as defined in the MITRE Adversarial Tactics, Techniques, and Common Knowledge (ATT&CK) framework. The enriched rule is deployed to a security system and, when the rule is activated against incoming telemetry, the associated MITRE tactic and technique are surfaced, this providing rich and targeted security context to the detection result.

In certain deployments, an administrator or other rule designer codes a detection rule in a predefined rule language or syntax. This typically includes specifying parameters like time thresholds, event sequences, or particular error codes that could signify malicious behavior. For example, repeated failed logins might be flagged if they indicate a brute force attempt, but such a rule is more effective when linked to a recognized tactic or technique.

In some embodiments, rule enrichment is performed at the point of creation. For example, some embodiments provide an interactive user interface, via which an administrator can code a rule and then instigate an automated classification of the rule, with which the rule is then enriched. By referencing a framework such as the MITRE ATT&CK framework, the rule carries contextual metadata that a security system can use to guide analyses or automate countermeasures when the rule activates. Attaching a documented MITRE technique or tactic to the rule consequently associates the rule with information about how an attack typically unfolds, what infrastructure components are at highest risk, and what measures are recommended to contain or mitigate a threat or potential threat (as documented in the ATT&CK framework). Consequently, analysts or automated systems can more quickly and precisely judge whether an incident is a mere anomaly or a genuine menace, allowing them to prioritize resources and counter the issue in an appropriate manner.

For instance, each detection rule may be associated with its assigned classification labels in a data repository accessible to the security system 107, ensuring the security system 107 can retrieve these labels promptly when the rule is triggered.

One embodiment employs a two-stage machine learning (ML) classification process. A first ML classifier determines a first threat classification label (e.g., relevant tactic) for the rule, e.g. using the code of the rule itself, a descriptor attached to the rule by the rule designer, or a combination of both. A second ML classifier further enriches this output by pinpointing a more precise second threat classification label (e.g., specific technique, drawing on data sets in which researchers labeled rules with known tactics and techniques). The classification is hierarchical in that the first threat classification label from the first ML classifier is passed as input to the second ML classifier. By using the (broad) first threat classification label to guide the assignment of the second (more specific) threat classification label, threat classification performance of the second ML classifier is improved. For the reasons discussed above, improved threat classification of the rule yields a downstream improvement in security when the rule is triggered, by surfacing more accurate and targeted security context with the detection to enable fast and targeted threat remediation action.

In some variants, an automated remediation action can occur after the classification, such as implementing a particular response measure mapped to the identified MITRE tactic or technique.

The described mechanism is particularly well suited to MITRE’s hierarchical approach to tactics and techniques, which provide valuable insight into threat behavior and fosters more comprehensive investigation or threat response. Nevertheless, the described techniques are not limited to MITRE and can be applied more generally to implement any form of hierarchical security classification.

When applied to multiple rules, increased labeling accuracy across the multiple rules raises overall security by ensuring each rule is consistently annotated.

By automatically identifying tactics and techniques, the system removes manual guesswork. It enforces consistent labeling for each rule, offering validated analysis rather than speculative assumptions. From a broader perspective, this approach strengthens security teams by standardizing how detection rules are structured around recognized categories. Once a detection rule is linked to a specific tactic or technique, analysts benefit from more contextual alerts and well-informed investigations that utilize real-world data for classification instead of conjecture.

FIG. 1 depicts a configuration system 100 that includes a user interface 104 for receiving input and a rule editor 102 for specifying a detection rule 103. Examples include an administrative portal or other interactive console that allows administrators to craft a detection rule 103. The environment is designed to make these rules simple to define, update, and share.

The configuration system 100 also includes a hierarchical rule classifier 106 that assigns a hierarchical threat classification to the detection rule 103. In some embodiments, a tactic label is generated along with a technique label, both of which can align with a recognized standard such as MITRE ATT&CK. By incorporating accepted frameworks, an organization can systematically map each rule to an underlying threat category for enriched coverage.

Once finalized, the detection rule 103 is deployed to a security system 107, where it is stored in association with the hierarchical classification 105. The configuration system 100 is where new rules are created and labeled, while the security system 107 enforces them. The security system 107 is shown to comprise a cybersecurity detector 108, which processes incoming telemetry (such as collected network data, endpoint data, security logs from endpoint devices, servers, cloud infrastructure etc., or any combination thereof). The detector 108 implements the detection rule 103, and the detection rule 103 is said to be activated or triggered when the detector 108 matches a pattern encoded in the detection rule 103 to a pattern exhibited in the telemetry.

The security system 107 is additionally shown to comprise a response engine 110 that executes an appropriate threat response action once the rule activates. On activation, the hierarchical classification 105 is obtained by the response engine 110 and used in determining the threat response action.

Examples of threat response actions include performing a predetermined remediation using the hierarchical classification 105 or generating alert indicating the hierarchical classification 105. The configuration system 100 and the security system collaborate by sharing detection rules together with classification data, ensuring that each new rule connects to relevant security context such as well-defined tactics and techniques for thorough coverage. This approach supports incident response and allows a consistent representation of the likely attack scenario.

The detection rule 103 comprises machine-readable code that encodes the aforementioned detection pattern. This code can be KQL, SPL, EQL, or any other suitable format for describing rule-based logic. Such patterns can range from single-event matching for known malicious indicators, sequence-based correlations between multiple events, threshold detections, unusual parent-child process relationships, or Indicator of Compromise (IoC) matching against threat intelligence lists. In deploying the detection rule 103, the cybersecurity detector 108 is thereby configured to perform pattern detection on the incoming telemetry based on pattern(s) encoded in the machine-readable code.

By automatically mapping each hierarchy of threat classification labels to corresponding response strategies, the system can promptly execute context-appropriate mitigations, such as revoking credentials or isolating devices, thus enabling a more targeted and efficient remediation.

In some implementations, the rule designer attaches one or more descriptors to the detection rule 103. Examples of descriptors include titles, summaries, or contextual notes.

In the present context, the rule code, the descriptor(s) or any parts or combination thereof are used by the hierarchical rule classifier 106 to assign the hierarchical classification 105 to the detection rule 103.

After the rule matches suspicious telemetry, the response engine 110 initiates a threat response, issuing an alert or undertaking an autonomous remediation measure to curtail the threat. Such remediation can involve isolating or deactivating a software component, such as an application or service, or restricting an account, such as a user or organizational profile. Because the rule is activated only when its underlying pattern aligns with observed data, this rules-based approach ensures a relevant and timely response to confirmed events.

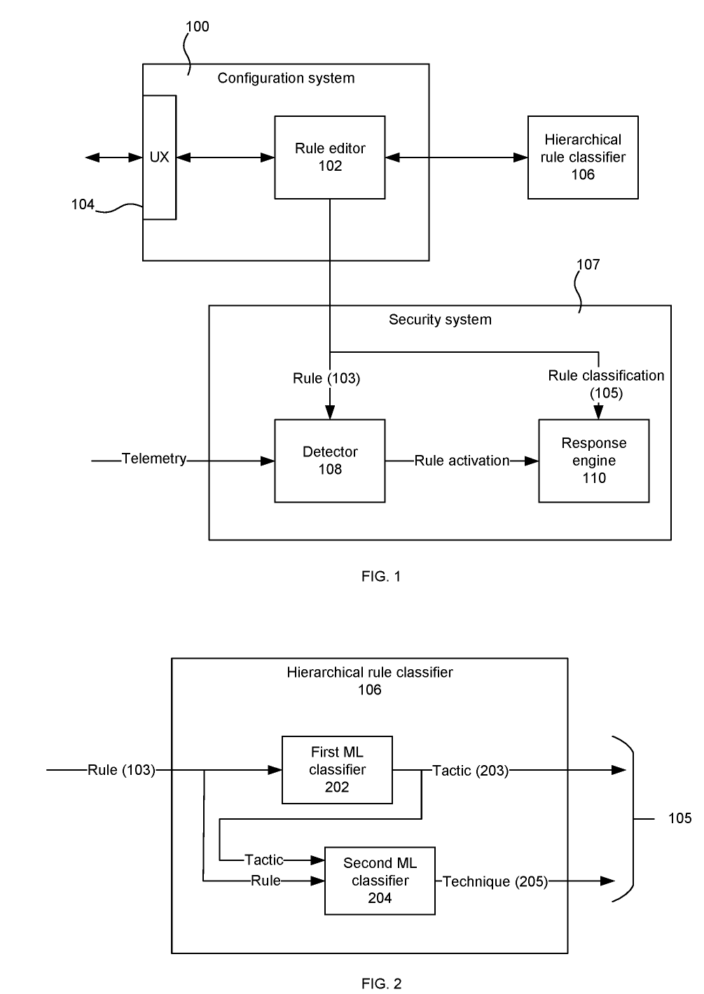

FIG. 2 shows a two-stage classification procedure in further detail in one example. A first ML classifier 202 receives as input the detection rule 103 (or a part or parts thereof) and assigns a first threat classification label signifying a tactic 203 in this example.

Once this tactic 203 is assigned, a second ML classifier 204 receives the rule 103 (or a part or parts thereof) as first input, together with the assigned tactic 203 as second input, which the second ML classifier 204 uses to assign a second threat classification label 205 indicating a technique in this example.

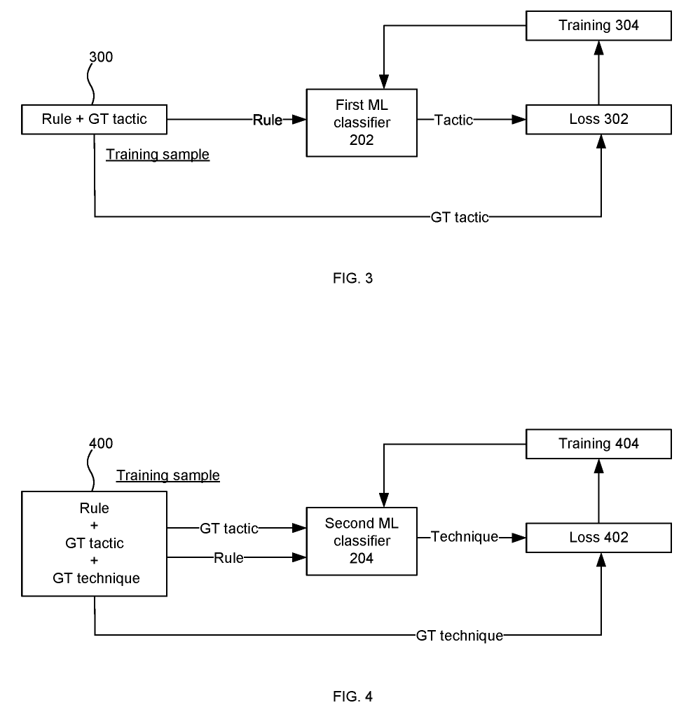

FIG. 3 depicts a training process for the first ML classifier 202 using a training sample 300 comprising a sample rule and an associated ground-truth tactic label. The classifier 202 processes the rule and outputs a predicted tactic, while a first loss function 302 measures an error between the predicted and the ground truth tactic label. A training component 304 then adjusts parameters of the first ML classifier 202 with the objective of reducing the measured error. Although a single training sample 300 is shown, in practice this is performed over a training set of multiple training samples, and the parameters are systematically adjusted to reduce aggregate error between predicated and ground truth tactics across the training set.

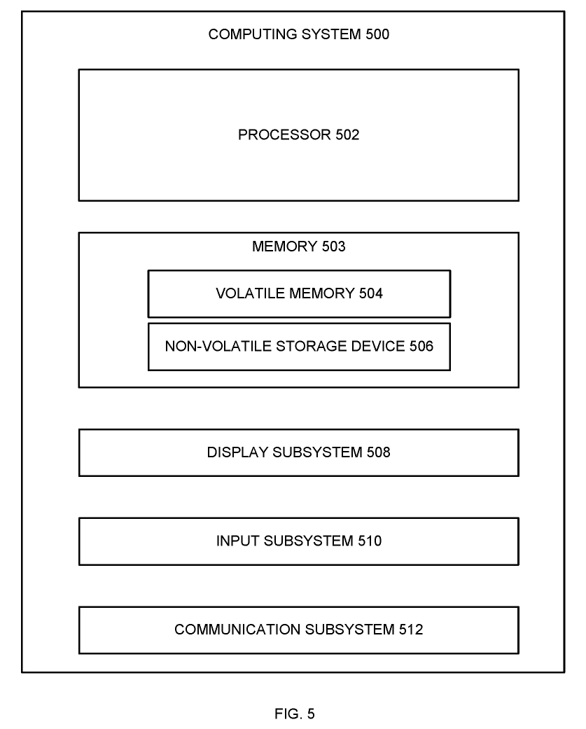

FIG. 4 illustrates a training process for the second ML classifier 204 using sample rule data 400. The sample rule data 400 is shown to comprise a rule together with a ground truth tactic label and ground truth technique label.

In one embodiment, the rule 103 is tokenized as text using a tokenizer (such as CountVectorizer, which transforms the rule 103 into a sparse feature matrix based on word frequency). The first ML model 202 has in this example a LightGBM-based multi-label architecture to predict multiple most-probable tactic labels. The rule tokenization and most-probable tactic labels are inputted to the second ML classifier 204, which also has a LightGBM architecture in this example, is specifically trained on technique detection. This is merely one example implementation, and the described multi-stage classification architecture can be implemented with different tokenization and classification architectures.

A training set can be constructed by collecting a set of expert-labelled rules. A training set of around several thousand more samples has been found to be sufficient, which is moderate in size compared to large-scale neural networks, and feasible to produce via manual or semi-automated (human-supervised) labeling. Purely by way of example, one suitable source of training is the Sentinel GitHub repository (available at https://github.com/Azure/Azure-Sentinel/tree/master/Solutions). One example implementation compiles a training by collecting detection rules that included labeled data, capturing rule title, description, corresponding KQL query, together with associated MITRE ATT&CK tactics and techniques as labeled.

At inference, as described above with reference to FIG. 2, the second ML classifier 204 post-training receives the predicted tactic from the trained first classifier 202. However, during training, in the present example, the second ML classifier 204 receives the ground truth tactic together with the rule as respective training inputs, from which it generates a predicted technique label. Hence, in this example, the second ML classifier 204 is trained independently of the first ML classifier 202. A second loss function 402 measures divergence between the predicted technique label and the ground-truth technique label. A training component 404 updates parameters of the second ML classifier 204 to reduce that divergence. As in FIG. 3, although a single training sample is shown, in practice training is performed across a training set of multiple such training samples to reduce aggregate divergence between predicted and ground truth techniques across the training set. Using the ground truth tactic for training has been found to achieve optimal technique classification accuracy.

Although FIGS. 3 and 4 are described with reference to techniques and techniques, the teaching applies more generally to other ground truth first and second threat classification labels, in any hierarchical threat classification scheme.

FIG. 5 schematically shows an example of a computer system 500, such as a computing device or system of connected computing devices configured to implement the system of FIGS. 1 and 2 or the training setups of FIGS. 3 and 4.

The computer system 500 is shown in simplified form. The computer system 500 comprises a processor 502 and a memory 503. In this example, the memory 503 is shown to comprise volatile memory 504 and a non-volatile storage 506. In this example, the computer system 500 includes a display subsystem 508, an input subsystem 510, and a communication subsystem 512. In other examples, one, some or all of these components 508, 510, 512 are omitted. The processor 502 comprises one or more hardware processing units configured to carry out processing operations. A hardware processing unit may be programmable or non-programmable. Certain hardware processing units are configured to execute computer-readable instructions based on an instruction set architecture. Examples of such a hardware processing unit include a central processing unit (CPU), graphics processing unit (GPU), tensor processing unit (TPU), neural processing unit (NPU), intelligence processing unit (IPU) or other form of accelerator processing unit. Such hardware processing units may be single-core or multi-core, and instructions executed thereon may be configured for sequential, parallel, and/or distributed processing. Other examples of such hardware processing units include a field-programmable gate array (FPGAs) or a non-programmable fixed-logic circuit, such as an application-specific integrated circuit (ASIC). The processor 502 is contained in a single device in some examples. Individual components of the processor 502 are distributed among two or more separate devices in other examples. In some such examples, such devices are remotely located from each other and/or configured for coordinated processing. The non-volatile storage 506 includes one or more physical devices configured to hold data and/or computer-readable instructions executable by the processor 502. Examples of non-volatile storages include optical memory (e.g., CD, DVD, HD-DVD, Blu-Ray Disc, etc.), semiconductor memory (e.g., ROM, EPROM, EEPROM, FLASH memory, etc.), magnetic memory (e.g., hard-disk drive), or other mass storage device technology. The volatile memory 504 includes one or more physical devices that include random access memory in some examples. The volatile memory 504 is typically utilized by processor 502 to temporarily store data and/or instructions during processing. The terms “module,” “program,” and “engine” are used to describe particular functionality of the computer system 500 implemented in hardware or software. In some examples, a software module, program, or engine is instantiated via the processor 502 executing instructions held by non-volatile storage 506, using portions of the volatile memory 504. Different modules, programs, and/or engines are instantiated from the same application, service, code block, object, library, routine, API, function, etc. in some examples. In other examples, the same module, program, and/or engine are instantiated by different applications, services, code blocks, objects, routines, APIs, functions, etc. The terms “module,” “program,” and “engine” encompass among other things individual or groups of executable files, data files, libraries, drivers, scripts, database records, etc. The display subsystem 508 is configurable to present a visual representation of data such as data held by the non-volatile storage 506. The visual representation takes the form of a graphical user interface (GUI) in some examples. The display subsystem 508 includes one or more display devices utilizing virtually any type of technology. Such display devices are combined with processor 502, volatile memory 504, and/or non-volatile storage 506 in a shared enclosure in some examples. In other examples, such display devices are peripheral display devices. The input subsystem 510 comprises or interfaces with one or more input devices such as user-input devices such as a keyboard, mouse, touch screen, or game controller. In some embodiments, the input subsystem 510 comprises or interfaces with selected natural user input (NUI) componentry. Such componentry may be integrated or peripheral, and the transduction and/or processing of input actions may be handled on-board or off-board. Examples of NUI componentry include without limitation a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity; and/or any other suitable sensor. The communication subsystem 512 is configured to communicatively couple the computer system 500 to another device or system. The communication subsystem 512 may include wired and/or wireless communication devices compatible with one or more different communication protocols. In some examples, the communication subsystem 512 allows computer system 500 to send and/or receive messages to and/or from other devices via a communication network such as the internet. The term computer readable media as used herein includes for example computer storage media. Computer storage media includes for example volatile and non-volatile, removable and nonremovable media (e.g., volatile memory 504 or non-volatile storage 506). Computer storage media includes for example solid-state storage, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information, and which can be accessed by a computing device (e.g., the computer system 500 or a component device thereof). Computer storage media does not include a carrier wave or other propagated or modulated data signal. Communication media is embodied by computer readable instructions, data structures, program modules, or other data in a modulated data signal, such as a carrier wave or other transport mechanism, and includes any information delivery media. The term “modulated data signal” describes a signal that has one or more characteristics set or changed in such a manner as to encode information in the signal. Examples of communication media include without limitation wired media such as a wired network or direct wired connection, and wireless media such as acoustic, radio frequency (RF), infrared, and other wireless media.

According to a first aspect herein, a computer-implemented method comprises assigning a first threat classification label to a detection rule using a first machine learning classifier, assigning a second threat classification label to the detection rule using a second machine learning classifier based on the first threat classification label, causing a cybersecurity detector to implement the detection rule on collected telemetry, and causing a response engine to implement, in response to an activation of the detection rule, a threat response action using the first threat classification label and the second threat classification label.

In embodiments, the first threat classification label comprises a tactic.

In embodiments, the tactic is a MITRE tactic.

In embodiments, the second threat classification label comprises a technique.

In embodiments, the tactic is a MITRE tactic, and the technique is a MITRE technique.

In embodiments, a detection rule comprises machine-readable code that encodes a detection pattern and is executable, and causing a cybersecurity detector to implement the detection rule comprises configuring the cybersecurity detector to execute the machine-readable code.

In embodiments, a first machine learning classifier or a second machine learning classifier is applied to the machine-readable code.

In embodiments, a detection rule has a descriptor associated therewith, and the first machine learning classifier or the second machine learning classifier is applied to the descriptor.

In embodiments, a threat response action comprises generating an alert comprising the first threat classification label and the second threat classification label.

In embodiments, a threat response action comprises an autonomous threat remediation action performed using the first threat classification label and the second threat classification label.

In embodiments, the autonomous threat remediation action comprises isolating or deactivating a device or software component associated with an activation of a detection rule, and deactivating or restricting an account associated with the activation of the detection rule.

Further aspects herein provide a computer system and computer-readable instructions configured to implement any method or functionality disclosed herein.

According to a second aspect herein, a computer-readable storage medium embodies computer-readable instructions configured when executed on a processor to assign a MITRE tactic to a detection rule using a first machine learning classifier, assign a MITRE technique to the detection rule using a second machine learning classifier based on the MITRE tactic, cause a cybersecurity detector to implement the detection rule on collected telemetry, and cause a response engine to implement, in response to an activation of the detection rule, a threat response action using the MITRE tactic and the MITRE technique.

According to a third aspect herein, a computer system comprises a memory embodying computer-readable instructions and a processor coupled to the memory and configured to execute the computer-readable instructions, which upon execution cause the computer system to assign a first threat classification label to a detection rule using a first machine learning classifier, assign a second threat classification label to the detection rule using a second machine learning classifier based on the first threat classification label, cause a cybersecurity detector to implement the detection rule on collected telemetry, and cause a response engine to implement, in response to an activation of the detection rule, a threat response action using the first threat classification label and the second threat classification label.

In embodiments, the computer system is further configured to train the first machine learning classifier based on a sample rule and a ground truth first threat classification label.

In embodiments, the computer system is further configured to train a second machine learning classifier based on a sample rule and a ground truth first threat classification label provided as respective training inputs to the second machine learning classifier, and a ground truth second classification label compared with an output of the second machine learning classifier during training.

In embodiments, the first threat classification label comprises a tactic.

In embodiments, the tactic is a MITRE tactic.

In embodiments, the second threat classification label comprises a technique.

In embodiments, the tactic is a MITRE tactic, and the technique is a MITRE technique.

In embodiments, a detection rule comprises machine-readable code that encodes a detection pattern and is executable, and causing a cybersecurity detector to implement the detection rule comprises configuring the cybersecurity detector to execute the machine-readable code.

The embodiments described above are illustrative and not exhaustive. Further embodiments are envisaged. Any feature described in relation to any one example or embodiment may be used alone or in combination with other features. In addition, any feature described in relation to any one example or embodiment may also be used in combination with one or more features of any other of the examples or embodiments, or any combination of any other of the examples or embodiments. Furthermore, equivalents and modifications not described herein may also be employed within the scope of the present disclosure. The scope is not defined by the described embodiments but only by the accompanying claims.

1. A computer-implemented method, comprising:
assigning a first threat classification label to a detection rule, using a first machine learning (ML) classifier;
assigning a second threat classification label to the detection rule, using a second ML classifier based on the first threat classification label;
causing a cybersecurity detector to implement the detection rule on collected telemetry; and
causing a response engine to implement, in response to an activation of the detection rule, a threat response action using the first threat classification label and the second threat classification label.

2. The method of claim 1, wherein the first threat classification label comprises a tactic.

3. The method of claim 2, wherein the tactic is a MITRE tactic.

4. The method of claim 2, wherein the second threat classification label comprises a technique.

5. The method of claim 4, wherein the tactic is a MITRE tactic, and the technique is a MITRE technique.

6. The method of claim 1, wherein the detection rule comprises machine-readable code that encodes a detection pattern and is executable, wherein causing the cybersecurity detector to implement the detection rule comprises configuring the cybersecurity detector to execute the machine-readable code.

7. The method of claim 6, wherein the first ML classifier or the second ML classifier is applied to the machine-readable code.

8. The method of claim 1, wherein the detection rule has a descriptor associated therewith, wherein the first ML classifier or the second ML classifier is applied to the descriptor.

9. The method of claim 1, wherein the threat response action comprises generating an alert comprising the first threat classification label and the second threat classification label.

10. The method of claim 1, wherein the threat response action comprises an autonomous threat remediation action performed using the first threat classification label and the second threat classification label.

11. The method of claim 10, wherein the autonomous threat remediation action comprises:
isolating or deactivating a device or software component associated with the activation of the detection rule,
deactivating or restricting an account associated with the activation of the detection rule.

12. A computer-readable storage medium embodying computer-readable instructions, configured when executed on a processor to cause the processor to:
assign a MITRE tactic to a detection rule, using a first machine learning (ML) classifier;
assign a MITRE technique to the detection rule, using a second ML classifier based on the MITRE tactic;
cause a cybersecurity detector to implement the detection rule on collected telemetry; and
cause a response engine to implement, in response to an activation of the detection rule, a threat response action using the MITRE tactic and the MITRE technique.

13. A computer system, comprising:
a memory embodying computer-readable instructions; and
a processor coupled to the memory and configured to execute the computer-readable instructions, which upon execution cause the computer system to perform operations of:
assigning a first threat classification label to a detection rule, using a first machine learning (ML) classifier;
assigning a second threat classification label to the detection rule, using a second ML classifier based on the first threat classification label;
causing a cybersecurity detector to implement the detection rule on collected telemetry; and
causing a response engine to implement, in response to an activation of the detection rule, a threat response action using the first threat classification label and the second threat classification label.

14. The computer system of claim 13, wherein said operations comprise:
training the first ML classifier based on a sample rule and a ground truth first threat classification label.

15. The computer system of claim 14, wherein said operations comprise:
training the second ML classifier based on a sample rule and a ground truth first threat classification label provided as respective training inputs to the second ML classifier, and a ground truth second classification label compared with an output of the second ML classifier during training.

16. The computer system of claim 13, wherein the first threat classification label comprises a tactic.

17. The computer system of claim 16, wherein the tactic is a MITRE tactic.

18. The computer system of claim 16, wherein the second threat classification label comprises a technique.

19. The computer system of claim 18, wherein the tactic is a MITRE tactic, and the technique is a MITRE technique.

20. The computer system of claim 13, wherein the detection rule comprises machine-readable code that encodes a detection pattern and is executable, wherein causing the cybersecurity detector to implement the detection rule comprises configuring the cybersecurity detector to execute the machine-readable code.
